(19) United States
(12) Patent Application Publication
(10) Pub. No.: US 2015/0309242 A1
(43) Pub. Date: Oct. 29, 2015

(54) DISPLAY DEVICE AND PROCESSING APPARATUS OF THE SAME

(71) Applicant: Innolux Corporation, Miao-Li County (TW)

(72) Inventors: Tai-Chi Pan, Miao-Li County (TW); Li-Ling Chen, Miao-Li County (TW); Bo-Tsuen Chen, Miao-Li County (TW)

(21) Appl. No.: 14/667,715

(22) Filed: Mar. 25, 2015

(30) Foreign Application Priority Data
Apr. 23, 2014 (TW) 103114666

(51) Int. Cl. F21V 8/00

(52) U.S. Cl. CPC G02B 6/0036; G02B 6/0031

(57) ABSTRACT

A display device and a processing apparatus of the same are provided. The display device includes a backlight module and a display panel. The backlight module includes a light guide component and at least a roughness structure. The light guide component has a light emitting surface, a light entering surface, and at least a side surface. The light emitting surface and the side surface are adjacent to each other and share an edge. The light entering surface is adjacent to the light emitting surface or the side surface. The roughness structure is formed on the side surface and has a surface roughness of 0.01-10 μm. The display panel is disposed corresponding to the light emitting surface.

This application claims the benefit of Taiwan application Serial No. 103114666, filed Apr. 23, 2014, the subject matter of which is incorporated herein by reference.

### BACKGROUND OF THE INVENTION

1. Field of the Invention

The invention relates in general to a display device and a processing apparatus of the same, and more particularly to a display device with improved light extraction and a processing apparatus of the same.

2. Description of the Related Art

Along with the advance in the modern video technology, liquid crystal displays (LCD) have been widely used in display screens of consumption electronic products, such as mobile phones, notebook computers, personal computers, and personal digital assistants. Since the LCD panel of an LCD is not self-luminous, the LCD panel needs to be equipped with a backlight module which provides a surface light source for the LCD panel and makes the LCD panel achieve displaying effect. The edge lighting backlight module advantageously possesses a smaller thickness and has been widely used in LCD devices, such as mobile phones, notebook computers, monitors, TVs, and personal digital assistants (PDA).

One of the functions of the light guide plate of an edge lighting backlight module is to guide the direction of the light, such that the luminance of the display panel can be increased, and the brightness uniformity of the display panel can be controlled. Normally, in order to increase the efficiency of light extraction of the light guide plate, a white reflective sheet is adhered on a side of the light guide plate to collect reflected lights and increase optical efficiency. However, the process of adhering the reflective sheet not only incurs extra labor and time, but also involves problems such as the alignment precision of tape adhesion and the conformity rate of the manufacturing process.

### SUMMARY OF THE INVENTION

The invention is directed to a display device and a processing apparatus of the same. According to the embodiments, the display device has a roughness structure which effectively reflects the light to the interior of the light guide component from a side surface of a light guide component, such that the loss of the light is reduced, and the efficiency of light extraction of the backlight module is increased.

According to one embodiment of the present invention, a display device is provided. The display device includes a backlight module and a display panel. The backlight module includes a light guide component and at least a roughness structure. The light guide component has a light emitting surface, a light entering surface, and at least a side surface. The light emitting surface and the side surface are adjacent to each other and share an edge. The light entering surface is adjacent to the light emitting surface or the side surface. The roughness structure is formed on the side surface and has a surface roughness of 0.01-10 μm. The display panel is disposed corresponding to the light emitting surface.

According to another embodiment of the present invention, a manufacturing method of a display device is provided. The manufacturing method includes the following steps: providing a backlight module, including: positioning a light guide component having a light emitting surface and at least a side surface, wherein the light emitting surface and the side surface are adjacent to each other and share an edge; providing a paint to form a coating layer on a side surface of the light guide component; and curing the coating layer for forming a roughness structure on the side surface, wherein the roughness structure has a surface roughness of 0.01-10 μm; and disposing a display panel corresponding to the light emitting surface.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an explosion diagram of a display device according to an embodiment of the disclosure;

FIG. 2 is an explosion diagram of a display device according to another embodiment of the disclosure; and

FIG. 3 is a schematic diagram of a processing apparatus of a display device according to an embodiment of the disclosure.

### DETAILED DESCRIPTION OF THE INVENTION

According to the embodiments of the present disclosure, the display device has a roughness structure which effectively reflects the light to the interior of the light guide component from a side surface of a light guide component, such that the loss of the light is reduced, and the efficiency of light extraction of the backlight module is increased. A number of embodiments are disclosed below with reference to accompanying drawings. It should be noted that the drawings are simplified so as to provide clear descriptions of the embodiments of the present disclosure, and the descriptions of the embodiments are for description purpose only, not for limiting the scope of protection of the present disclosure. Anyone who is skilled in the technology field of the present disclosure can made necessary modifications or variations to the structures of the disclosure to meet the needs of actual implementations.

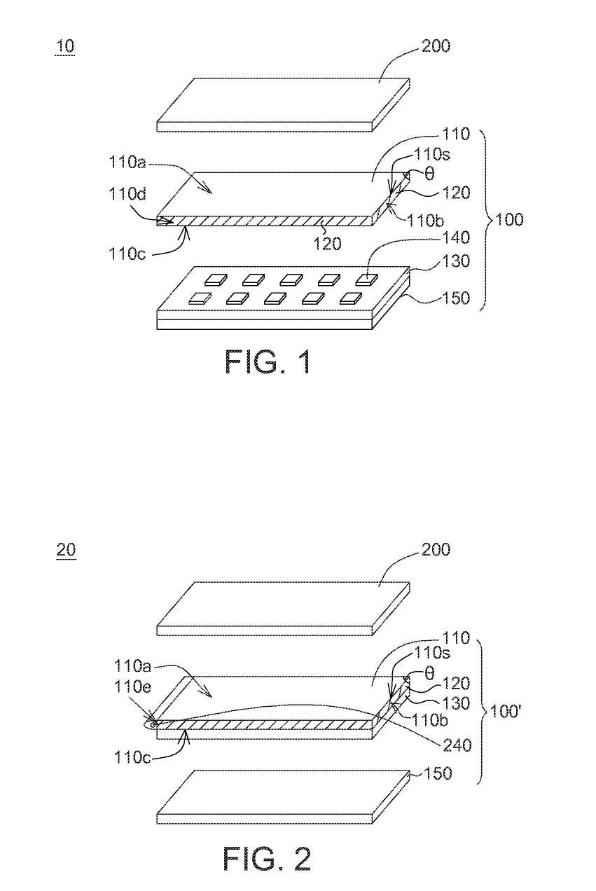

FIG. 1 is an explosion diagram of a display device 10 according to of the disclosure an embodiment. As indicated in FIG. 1, the display device 10 includes a backlight module 100 and a display panel 200. The backlight module 100 includes a light guide component 110 and at least a roughness structure 120. The light guide component 110 has a light emitting surface 110a, a light entering surface, and at least a side surface 110b. The light emitting surface 110a and the side surface 110b are adjacent to each other and share an edge 110s. The roughness structure 120 is formed on the side surface 110b. The roughness structure 120 has a surface roughness of 0.01-10 μm. The display panel 200 is disposed corresponding to the light emitting surface 110a. The light entering surface is adjacent to the light emitting surface or the side surface. That is, the light entering surface may be adjacent to the side surface and located opposite to the light emitting surface; alternatively, the light entering surface may be adjacent to the light emitting surface and located on a side of the light guide component 110.

In an embodiment, the light guide component 110 is such as a light guide plate, and the roughness structure 120 can effectively reflects the light to the interior of the light guide component 110 from the side surfaces 110b of the light guide component 110, such that the loss of the light is reduced, and the efficiency of light extraction of the backlight module 100 is increased.

Furthermore, in comparison to the conventional method of adhering a reflective sheet onto the side surface 110b, the roughness structure 120 is directly formed on the side surface 110b according to embodiments of the present disclosure, hence saving the labor and time cost required for adhering the reflective sheet, greatly reducing the probability of alignment error and avoiding the difficulty of rework which would otherwise occur if the adhering process ends up with alignment error. Thus, the present disclosure not only effectively reduces the labor and time cost of the manufacturing process but further increases the conformity rate of the manufacturing process.

In an embodiment, the roughness structure 120 may have a surface roughness of such as 0.01-5 μm.

As indicated in FIG. 1, the light emitting surface 110a and the side surface 110b are adjacent to each other and form an angle θ. The angle θ formed by the light emitting surface 110a and the side surface 110b is not equal to 180°. In an embodiment, the light emitting surface 110a and the side surface 110b are adjacent to each other and form an angle θ of about 80-100°. For example, the angle θ is about equal to 90°.

As indicated in FIG. 1, the light guide component 110 has a bottom surface 110c opposite to the light emitting surface 110a. In the embodiment, the surface roughness of the bottom surface 110c is different from the surface roughness of the roughness structure 120.

In the embodiment, the roughness structure 120 on the side surfaces 110b of the light guide component 110 can be formed by way of spraying or coating.

In the embodiment, the roughness structure 120 may include a thermal curing layer or a UV curing layer.

In the embodiment, the roughness structure 120 may include water paint, oil paint, titanium dioxide, photoinitiator, propylene glycol monomethyl ether acetate, methoxybutyl acetate ester, acrylic monomers, acrylic resin, polysiloxane, paint additive, barium sulfate, epoxy resin oligomer, amino oligomer, a dispersing agent, a leveling agent, titanium dioxide, an aromatic solvent or a combination of at least two of the above components.

In the embodiment, the roughness structure 120 may further comprise a plurality of highly reflective particles, such as titanium dioxide particles, barium sulfate (BaSO₄), air bubbles or a combination of at least two of the above components.

As indicated in FIG. 1, the backlight module 100 may further include a reflective sheet 130 disposed on a surface of the light guide component 110 opposite to the light emitting surface 110a. In other words, the reflective sheet 130 is disposed corresponding to the bottom surface 110c of the light guide component 110. In the embodiment, the backlight module 100 may further include a back plate 150, and the reflective sheet 130 is disposed on the back plate 150. In the embodiment, the reflective sheet 130 can be formed on the back plate 150 by way of adhering or coating.

In the embodiment, the backlight module 100 may further include a backlight source 140 disposed between the reflective sheet 130 and the light guide component 110. As indicated in FIG. 1, the backlight source 140 is disposed on the reflective sheet 130. In the embodiment, the backlight source 140 may include such as a plurality of organic light emitting diodes. In the present embodiment, the backlight module 100 is such as a bottom lighting backlight module. However, the selection of the backlight source 140 is not limited thereto and may be depending on actual needs.

In an embodiment as indicated in FIG. 1, the roughness structure 120 may also be formed on other side surfaces of the light guide component 110 adjacent to the light emitting surface 110a. For example, the roughness structure 120 may be formed on a side surface 110d of the light guide component 110. In some other embodiments, the backlight module 110 is exemplified by a direct-type backlight module, and the roughness structure 120 may be formed on any of the four side surfaces of the light guide component 110 adjacent to the light emitting surface 110a.

FIG. 2 is an explosion diagram of a display device 20 according to another embodiment of the disclosure. The components common to the present embodiment and the above embodiments retain the same numeric designation to indicate the same components whose descriptions are already disclosed and are not repeated here.

As indicated in FIG. 2, the display device 20 includes a backlight module 100′ and a display panel 200. The backlight module 100′ includes the light guide component 110 and at least one roughness structure 120. The light guide component 110 has the light emitting surface 110a and at least one side surface 110b. The light emitting surface 110a and the side surface 110b are adjacent to each other and share the edge 110s. The light emitting surface 110a and the side surface 110b form the angle θ. The roughness structure 120 is formed on the side surface 110b and has a surface roughness of 0.01-10 μm. The display panel 200 is disposed corresponding to the light emitting surface 110a.

As indicated in FIG. 2, the backlight module 100′ may further include the reflective sheet 130 disposed on a surface opposite to the light emitting surface 110a of the light guide component 110. In other words, the reflective sheet 130 is disposed corresponding to the bottom surface 110c of the light guide component 110. In the embodiment, the reflective sheet 130 is disposed on the bottom surface 110c of the light guide component 110. In the embodiment, the reflective sheet 130 may be formed on the bottom surface 110c of the light guide component 110 by way of adhering or coating, or may be directly disposed underneath the bottom surface 110c of the light guide component 110.

In the embodiment, the backlight module 100′ may further include the back plate 150, and the reflective sheet 130 is disposed between the back plate 150 and the light guide component 110.

In the present embodiment, the backlight module 100′ may further include a backlight source 240 disposed on a side of the light guide component 110. For example, the backlight source 240 is disposed adjacent to a side surface 110e of the light guide component 110 as indicated in FIG. 2. In the embodiment, the backlight source 240 may include such as a cold cathode fluorescent tube (CCFL) or an organic light emitting diode (LED). In the present embodiment, the backlight module 100 can be realized by such as an edge lighting backlight module. However, the selection of the backlight source 240 is not limited thereto and may be depending on actual needs.

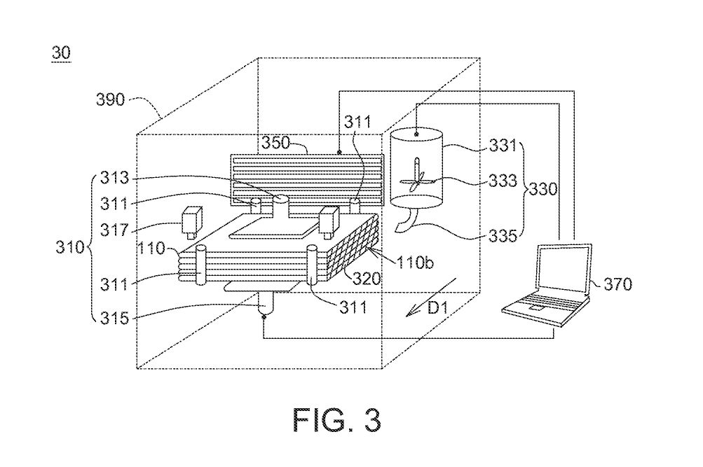

FIG. 3 is a schematic diagram of a processing apparatus 30 of a display device according to an embodiment of the disclosure. As indicated in FIG. 3, the processing apparatus 30 includes a positioning mechanism 310, a spray coating device 330, and a curing device 350. The positioning mechanism 310 positions the light guide component 110. The spray coating device 330 provides a paint to form a coating layer on the side surfaces 110b of the light guide component 110. The curing device 350 cures the coating layer. In the embodiment, the processing apparatus 30 may further include an automatic control system 370 for processing and transferring signals of automatic positioning, automatic spraying, and automatic curing. The positioning mechanism 310 is disposed adjacent to the spray coating device 330 and the curing device 350.

In the embodiment, the positioning mechanism 310 may include a plurality of positioning studs 311, clampers 313 and 315, a rotation motor (not illustrated), and an alignment monitor 317. When stacked light guide components 110 are transferred to the processing apparatus 30, the positioning studs 311 fix the light guide components 110 on a position on the X-Y plane. Then, the top and bottom clampers 313 and 315 clamp the light guide components 110 from the top and the bottom respectively to fix the light guide components 110 along the Z-axis direction. In greater details, the light guide components 110 are transferred to the processing apparatus 30 through a conveyer first. Then, the positioning studs 311 are raised and are pushed by pressure rods to fix the light guide components 110, such that the light guide components 110 are clamped by the clampers 313 and 315. After that, the alignment monitor 317 reads the coordinates of the light guide components 110 and transfers the coordinate signals to the spray coating device 330. In the embodiment, the alignment monitor 317, such as a charge coupling device (CCD), reads an alignment mark on the light guide components 110 to determine whether the alignment is successful. The alignment mark is such as a cutting angle on the glass substrate of the light guide components 110, and the cutting angle can be formed in a cutting process. In other words, the positioning mechanism 310 can automatically position the light guide components 110.

In the embodiment, the spray coating device 330 may include a paint container 331, a mixer 333, a heater (not illustrated), a linear motor (not illustrated), an air valve (not illustrated), a pressure sensor, and a spray head 335. The linear motor can drive the spray head 335 to move along an extending direction D1 of side surfaces 110b of the light guide components 110. When the spray coating device 330 receive the coordinate signals of the light guide components 110 from the alignment monitor 317, the spray head 335 moves to be adjacent to the side surfaces 110b of the light guide components 110 and provides a paint to form a coating layer 320 on the side surfaces 110b of the light guide components 110. In the embodiment, the spray head 350 sprays the paint onto the side surfaces 110b of the light guide components 110 in a non-contact manner for forming the coating layer 320. In the embodiment, after the pressure sensor senses and defines the interval between the light guide components 110 and the spray head 335, the air valve controls the spray volume of the paint, and the linear motor controls the moving speed of the spray head 335. Further, the mixer 333 can prevent the paint from being coagulated inside the paint container 331. The heater can adjust the temperature of the paint and further adjust the properties of the paint to be suitable for spraying. For example, the viscosity, uniformity and concentration of the paint are adjusted to suitable levels. Thus, the mixer 333 and the heater can be used to adjust the properties of the paint to achieve a uniform coating. In other words, the spray coating device 330 can automatically spray the coating layer 320 on the light guide components 110.

In another embodiment, the spray coating device 330 may also include a brush (not illustrated). That is, the brush may replace the spray head 335 to coat the coating layer 320 on the side surfaces 110b of the light guide components 110. In the embodiment, the brush coats the paint onto the side surfaces 110b of the light guide components 110 in a contact manner to form the coating layer 320.

In the embodiment, the curing device 350 may be a thermal curing device or a UV light curing device. That is, the curing method is determined based on the properties of the paint. In the embodiment, after the coating layer 320 is formed on one side surface 110b of the light guide component 110, the positioning mechanism 310 rotates the light guide component 110 by 90° along the X-Y plane, such that the side surface with the coating layer 320 is rotated to face the curing device 350 and is cured. In the embodiment, the top and bottom clampers 313 and 315 are driven by the rotation motor to rotate the light guide component 110. In other words, the curing device 350 can automatically cure the coating layer 320 on the light guide component 110 to form a roughness structure 120.

In an embodiment, the curing device 350, such as the UV light curing device, includes a UV radiator, a dose sensor, and a pneumatic cylinder. The dose sensor checks the radiation energy of the UV light. After the coating layer 320 is formed on the light guide components 110, the clampers 313 and 315 rotate the side surface coated with the coating layer 320 to face the UV radiator. Then a UV curing process is performed on the coating layer 320. The pneumatic cylinder disposed outside the UV radiator can move the UV radiator to be close to the coating layer 320 of the light guide component 110, such that the UV curing effect can be increased.

In an embodiment, the curing device 350, such as a thermal curing device, includes a heating plate, a temperature sensor, and a pneumatic cylinder. The temperature sensor checks the heating energy. After the coating layer 320 is formed on the light guide components 110, the clampers 313 and 315 rotate the side surface coated with the coating layer 320 to face the heating plate. Then a thermal curing process is performed on the coating layer 320. The pneumatic cylinder disposed outside the heating plate can move the heating plate to be close to the coating layer 320 of the light guide components 110, such that the thermal curing effect can be increased.

According to the embodiments of the present disclosure, the curing device 350 may include a UV light curing device and a thermal curing device at the same time. The UV light curing device and the thermal curing device can be disposed on the same side surface or on different side surfaces.

In an embodiment, the processing apparatus 30 may further include a reaction chamber 390, wherein the positioning mechanism 310, the spray coating device 330, and the curing device 350 are all disposed inside the reaction chamber. The design of disposing the positioning mechanism 310, the spray coating device 330, and the curing device 350 inside the same reaction chamber 390 not only shortens the manufacturing time, but also avoids possible collisions or pollutions of the light guide components 110 in transit and reduces the probability of the light guide components 110 having defects or damages, hence increasing the conformity rate of the manufacturing process and saving the manufacturing costs.

The present disclosure is further exemplified with embodiments shown below. Table 1 shows the main materials of the roughness structures of the display devices of the embodiments and measured results thereof. The surface roughness (Ra) of the present embodiment is measured by using a surface roughness tester (Instrument: Mitutoyo; Model: SJ-210), and the efficiency of light extraction is measured by using a large integrating sphere measurement module. However, the present embodiments are for description purpose only, not for limiting the scope of protection of the present disclosure.

TABLE 1

| | Average | |
|---|---|---|
| | Surface | Efficiency |
| Materials of the Roughness Structure | Roughness | of Light |
| of the Sample | (μm) | Extraction (%) |
| N/A (lacking roughness structures) | 0.010 | 82% |
| Oil Paint I | 0.017 | 92.3% |
| White Titanium Dioxide | 0.018 | 94.7% |
| Dispersion-type liquid Photoresist I | | |
| White Titanium Dioxide | 0.025 | 93.4% |
| Dispersion-type liquid Photoresist II | | |
| (having a coating thickness different | | |
| from that of white titanium dioxide | | |
| dispersion-type liquid photoresist I) | | |
| Titanium Dioxide And Titanium Dioxide | 0.041 | 91.20% |
| Dispersion-Type Liquid Photoresist | | |
| (Shinih paint) | | |
| Titanium Dioxide Mixed Epoxy | 0.043 | 90% |
| Oligomers (UV curing type white ink) | | |
| White Titanium Dioxide | 0.045 | 97% |
| Dispersion-Type Liquid Photoresist | | |
| (having a viscosity different that of the | | |
| previous one; ESWR-I802-100-1) | | |
| Water Paint | 0.117 | 97% |
| Water-Based Acrylic Paint | 0.136 | 97% |
| Oil Paint II (having a viscosity different | 1.600 | 96% |
| from that of the oil paint I) | | |

It is clearly shown from the results of Table 1 that the material (or mixture of materials) of the roughness structure of the sample affects the surface roughness, and the overall light extraction is affected by the material and the surface roughness of the roughness structure. Therefore, the light extraction of the display device can be adjusted by adjusting the material and the surface roughness of the roughness structure.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a backlight module, comprising:
a light guide component having a light emitting surface, a light entering surface, and at least a side surface, wherein the light emitting surface and the side surface are adjacent to each other and share an edge, and the light entering surface is adjacent to the light emitting surface or the side surface; and
at least a roughness structure formed on the side surface, wherein the roughness structure has a surface roughness of 0.01-10 μm; and
a display panel disposed corresponding to the light emitting surface.

2. The display device according to claim 1, wherein the roughness structure has a surface roughness of 0.01-5 μm.

3. The display device according to claim 1, wherein the light guide component has a bottom surface opposite to the light emitting surface and the bottom surface has a surface roughness different from the surface roughness of the roughness structure.

4. The display device according to claim 1, wherein the roughness structure comprises a thermal curing layer or a UV curing layer.

5. The display device according to claim 1, wherein the roughness structure comprises water paint, oil paint, titanium dioxide, photoinitiator, propylene glycol monomethyl ether acetate, methoxybutyl acetate ester, acrylic monomers, acrylic resin, polysiloxane, paint additive, barium sulfate, epoxy resin oligomer, amino oligomer, a dispersing agent, a leveling agent, titanium dioxide, an aromatic solvent or a combination of at least two of the above components.

6. The display device according to claim 1, wherein the roughness structure comprises a plurality of highly reflective particles.

7. The display device according to claim 1, wherein the roughness structure comprises titanium dioxide particles, barium sulfate (BaSO₄), air bubbles or a combination of at least two of the above components.

8. The display device according to claim 1, wherein the light emitting surface and the side surface are adjacent to each other and form an angle of 80-100°.

9. The display device according to claim 1, wherein the backlight module further comprises:
a reflective sheet disposed on a surface opposite to the light emitting surface of the light guide component; and
a backlight source disposed between the reflective sheet and the light guide component or on a side of the light guide component.

10. A manufacturing method of a display device, comprising:
providing a backlight module, comprising:
positioning a light guide component having a light emitting surface and at least a side surface, wherein the light emitting surface and the side surface are adjacent to each other and share an edge;
providing a paint to form a coating layer on a side surface of the light guide component; and
curing the coating layer for forming a roughness structure on the side surface, wherein the roughness structure has a surface roughness of 0.01-10 μm; and
disposing a display panel corresponding to the light emitting surface.
